(19) United States
(12) Patent Application Publication
(10) Pub. No.: US 2016/0072965 A1
(43) Pub. Date: Mar. 10, 2016

(54) INDEXING SYSTEM FOR A PRINTING PRESS

(71) Applicant: Michael A. Vandenberg, Loveland, OH (US)

(72) Inventor: Michael A. Vandenberg, Loveland, OH (US)

(21) Appl. No.: 14/846,757

(22) Filed: Sep. 5, 2015

Related U.S. Application Data
(60) Provisional application No. 62/046,916, filed on Sep. 6, 2014.

(51) Int. Cl. H04N 1/00; B41F 3/54

(52) U.S. Cl. CPC H04N 1/00005; B41F 3/54

(57) ABSTRACT

A system is disclosed for adjusting a printing press prior to operation of a print job. The system includes an Anilox roll of the printing press, a printing cylinder of the printing press, an impression cylinder of the printing press; and a computerized device. The computerized device includes programming configured to monitor print job parameters, automatically control a distance between the Anilox roll and the printing cylinder, calculate an index factor based upon the print job parameters and an ideal roller position function configured to output an ideal distance between centerlines of the printing cylinder and the impression cylinder, and output upon a display device the index factor for manual adjustment of the printing press.

### CROSS REFERENCE TO RELATED APPLICATIONS

This disclosure claims the benefit of U.S. Provisional Application No. 62/046,916 filed on Sep. 6, 2015 which is hereby incorporated by reference.

### TECHNICAL FIELD

This disclosure is related to an object for use in printing upon a substrate. In particular, the disclosure is related to a system for adjusting a printing press for roll pressure or pressure between printing rollers within the machine needed to correctly perform a particular print job.

### BACKGROUND

The statements in this section merely provide background information related to the present disclosure. Accordingly, such statements are not intended to constitute an admission of prior art.

A printing press creates a printed pattern on a substrate such as paper. A system of rollers pulls the substrate through the press, one roller (an Anilox roll) applies ink to a printing plate upon another of the rollers (a plate roll), and the roller with the printing plate in combination with a third roller (an impression cylinder) prints an image upon the substrate. However, printing plates change and include different details and different plate detail dimensions with every print job. Different substrates include different thicknesses. Too little pressure or too much pressure between the rollers can cause defects in the printed material or print output. Printing presses must be adjustable, permitting a press operator to adjust pressure or position between rollers of the press to successfully create the printed material.

A manual adjustment system is known, wherein a set of control knobs or other input devices are used by an experienced operator to set pressure between rollers in the printing press. This system is highly dependent upon the skill and experience of the operator and can cause both significant waste and time delays in trial an error set up procedures. An automated adjustment system is known, wherein sensors within the machine detect roller positions and utilize servo motors to adjust the rollers based upon the sensor inputs. However, such systems are prohibitively expensive and the sensors are prone to failure and contamination from the inherently dusty/pulp powder/ink contaminant environment of the printing press.

### SUMMARY

A system is disclosed for adjusting a printing press prior to operation of a print job. The system includes an Anilox roll of the printing press, a printing cylinder of the printing press, an impression cylinder of the printing press; and a computerized device. The computerized device includes programming configured to monitor print job parameters, automatically control a distance between the Anilox roll and the printing cylinder, calculate an index factor based upon the print job parameters and an ideal roller position function configured to output an ideal distance between centerlines of the printing cylinder and the impression cylinder, and output upon a display device the index factor for manual adjustment of the printing press.

### BRIEF DESCRIPTION OF THE DRAWINGS

One or more embodiments will now be described, by way of example, with reference to the accompanying drawings, in which:

FIG. 1 illustrates an exemplary embodiment of a printing press configured for hybrid indexing adjustment, in accordance with the present disclosure;

FIG. 2A illustrates an exemplary roller position control assembly for a printing press, including a vertical position mechanism for a printing cylinder and a horizontal control mechanism controlling rotation of a printing cylinder and Anilox carrier, wherein the vertical position is being altered, in accordance with the present disclosure;

FIG. 2B illustrates the roller position control assembly of FIG. 2A, wherein the rotation of the printing cylinder and Anilox carrier is being altered, in accordance with the present disclosure;

FIG. 3 schematically illustrates a computerized hybrid indexing adjustment control module, in accordance with the present disclosure;

FIG. 4 is a flow chart illustrating an exemplary process for hybrid indexing adjustment of a printing press, in accordance with the present disclosure;

FIG. 5 illustrates a display and a pair of manual horizontal control knobs for a printing press, the display illustrating a determined index factor and aiding in manual adjustment of the knobs, in accordance with the present disclosure; and

FIG. 6 illustrates an exemplary alternative hardware configuration that can be used to adjust roller positions.

### DETAILED DESCRIPTION

Printing presses must be adjusted as part of a set-up process in preparation for operating a print job. Positions of or distances between centerlines of the various rollers must be set to ensure proper transfer of ink from an Anilox roll to a plate roll and proper printing upon the substrate by the plate roll and an impression cylinder. A hybrid adjustment system is provided, utilizing a computerized process to monitor inputs affecting proper selection of roller positions and providing an indexing output or outputs for adjustment of the press.

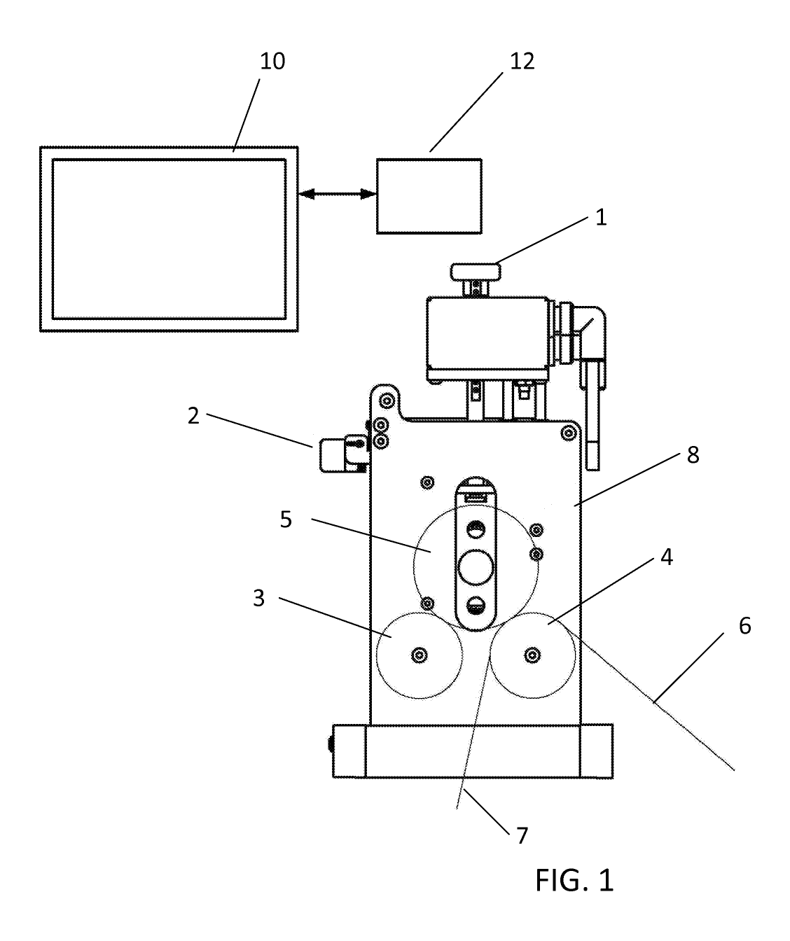

Referring now to the drawings, wherein the showings are for the purpose of illustrating certain exemplary embodiments only and not for the purpose of limiting the same, FIG. 1 illustrates an exemplary embodiment of a printing press configured for hybrid indexing adjustment. Printing press 8 is illustrated including a printing cylinder 5, an Anilox roll 3, and an impression cylinder 4. Printing cylinder 5, Anilox roll 3, and impression cylinder 4 are rotated, and draw supply paper 6 through printing press 8 in order to produce printed product 7.

Roller positions or distances between the centerlines of the rollers are important to operation of the printing press and the quality of the resulting printed product 7. Adjustment of the roller positions can be done manually. Operators can manually adjust the positions of the rollers to get desired qualities in the printed product. Such manual adjustment is highly operator dependent. Further, trial and error of getting the correct distances between the rollers can be expensive and time consuming

Automatic adjustment of roller positions is known. However, the input variables for any print job are complex. Factors such as the thickness of the paper, the details upon the printing cylinder, properties of the ink, temperature, wear upon the bearings of the printing press, etc. can cause automated control of the distances between the rollers problematic. An operator usually must fine tune the printing press after automatic control has been implemented.

Some factors of the printing press are not as complex. An ideal distance between centerlines of the Anilox roll and the printing cylinder can be determined or preset based upon factors such as knowledge of the ink and the details upon the printing cylinder. However, interaction between the printing cylinder and the impression cylinder are more complex. Skilled operators understand the need to apply enough pressure between the rollers to achieve a full print upon the paper while not having too much pressure which causes dot gain, changes in density reading, and/or a halo effect.

A hybrid indexing adjustment process and system is disclosed, wherein a vertical position of the printing cylinder is automatically controlled based upon input parameters of the print job and wherein an indexing control factor or index providing recommended rotation of a printing cylinder and Anilox carrier is determined and displayed to an operator. In one embodiment, the operator can use the index to manually control the rotation of a printing cylinder and Anilox carrier, thereby controlling a distance between the printing cylinder and the impression cylinder according to the index. In another embodiment, the operator is provided with an option to automatically set the rotation of the printing cylinder and Anilox carrier or to manually set the rotation.

Returning to FIG. 1, an automated vertical position control mechanism 1 is illustrated which is configured to move printing cylinder 5 up and down, changing distances between centerlines of both the printing cylinder 5 and the Anilox roll 3 and the printing cylinder 5 and the impression cylinder. A manual control knob 2 is illustrated enabling an operator to control a horizontal control mechanism which in turn controls rotation of a carrier device which includes both printing cylinder 5 and Anilox roll 4. Rotation of the carrier device alters the distance between printing cylinder 5 and impression cylinder 3 without changing the distance between printing cylinder 5 and Anilox roll 4. Manual control knob 2 can optionally be supplemented with an automated control system permitting an operator to select between manual and automatic control.

Exemplary touch screen input/output device 10 is illustrated communicatively connected to a computerized hybrid indexing adjustment control module 12. Any number of alternative input/output devices known in the art can be used in addition to or in the alternative to touch screen device 10. Control module 12 includes a computerized device configured to operate programming, monitor electronic inputs, and provide electronic outputs. Control module 12 monitors inputs from the operator through touch screen device 10 and input from printing press 8 through sensors and/or electric motor feedback from press 8. Inputs to control module 12 can include parameters for a particular print job and instructions for the printing press 8.

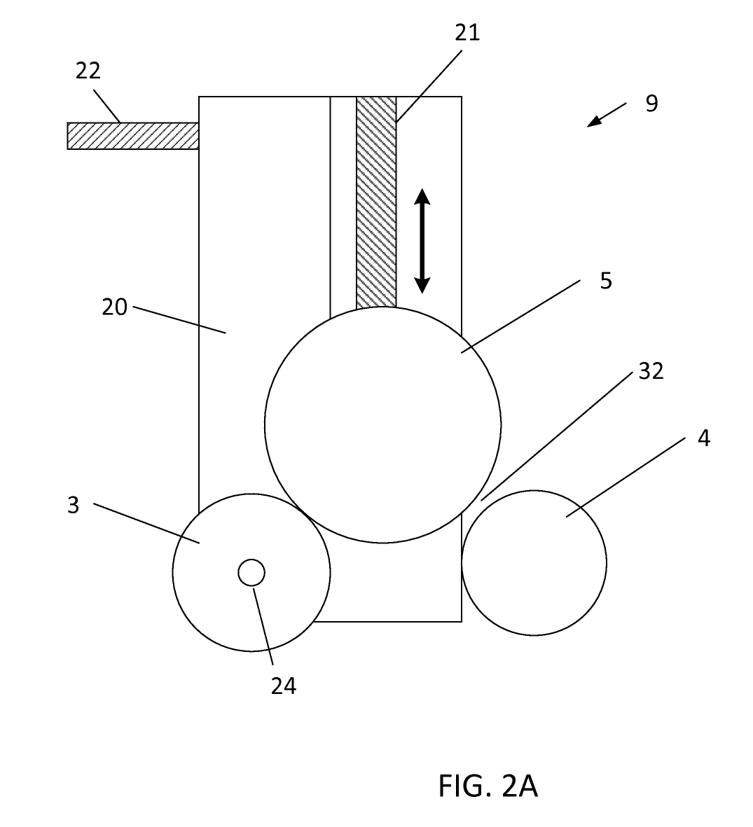

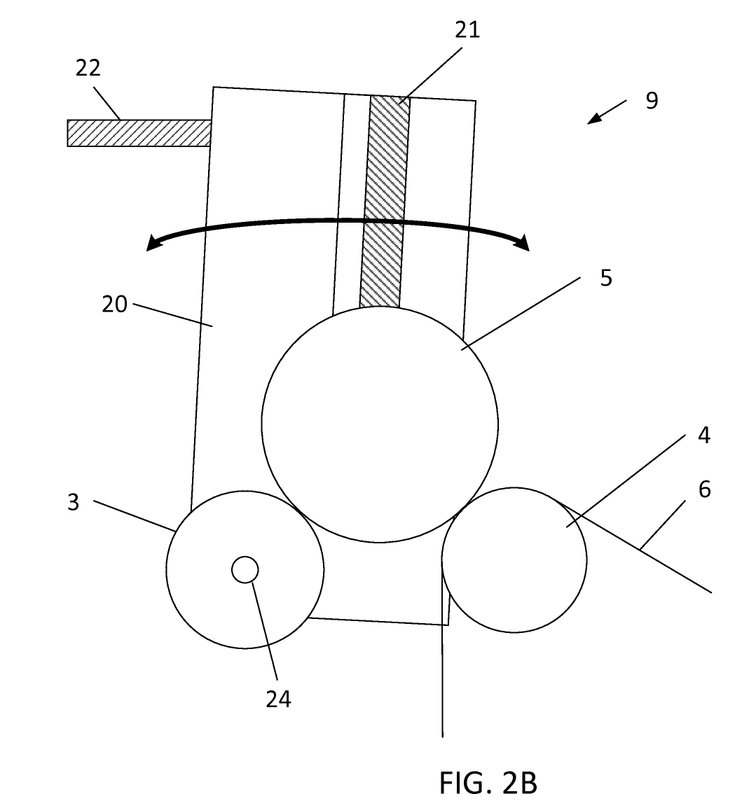

FIG. 2A illustrates an exemplary roller position control assembly for a printing press, including a vertical position mechanism for a printing cylinder and a horizontal control mechanism controlling rotation of a printing cylinder and Anilox carrier, wherein the vertical position is being altered. Roller position control assembly 9 includes printing cylinder 5, Anilox roll 3, impression cylinder 4, and printing cylinder and Anilox carrier 20. Carrier 20 includes pivot 24 around which carrier 20 can rotate, as controlled by horizontal control mechanism 22. Vertical position mechanism 21 is illustrated mounted to carrier 20 and controlling a vertical position of printing cylinder 5. Movement of printing cylinder 5 alters distances between printing cylinder 5 and both the Anilox roll 3 and the impression cylinder 4. In an exemplary process where the vertical position mechanism 21 is used to first set a distance between the printing cylinder 5 and the Anilox roll 3, and this distance will be held steady in a later second step while the distance between the printing cylinder 5 and the impression cylinder 4 are changed, a gap 32 can be maintained during adjustment of vertical position mechanism 21.

FIG. 2B illustrates the roller position control assembly of FIG. 2A, wherein the rotation of the printing cylinder and Anilox carrier is being altered. Roller position control assembly 9 includes printing cylinder 5, Anilox roll 3, impression cylinder 4, and printing cylinder and Anilox carrier 20 Vertical position mechanism 21 is illustrated mounted to carrier 20. Carrier 20 includes pivot 24 around which carrier 20 can rotate, as is controlled by horizontal control mechanism 22. Extension or retraction of horizontal control mechanism 22 can control rotation of carrier 20 about pivot 24, thereby controlling a distance between centerlines of printing cylinder 5 and impression cylinder 4 and the pressure applied to supply paper 6.

The positions and adjustment of the positions includes small distances and incremental distances, respectively. For purposes of illustration, the printing cylinder and Anilox carrier 20 of FIG. 2B is illustrated with a perceptible tilt. It will be appreciated that an actual rotation of the printing cylinder and Anilox carrier can include small angles and does not necessarily include perceptible tilting or rotation of the printing cylinder and Anilox carrier.

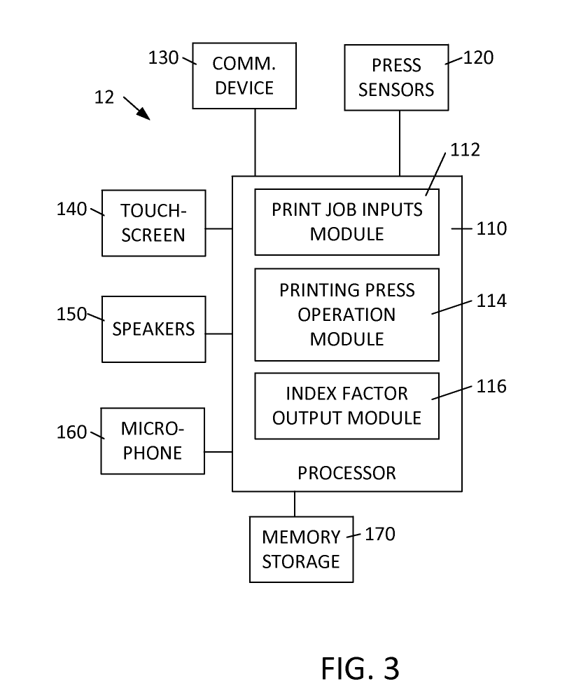

FIG. 3 schematically illustrates a computerized hybrid indexing adjustment control module. Control module 12 is exemplary of systems and devices which can operate computer programming to make determinations and provide an output display based upon monitored electronic inputs. Control module 12 includes a processor 110 configured to operate programmed code, RAM memory, and durable memory storage 170 embodied as a hard drive, flash memory, or other similar devices. Processor 110 operates programming modules which are configured to operate programming accomplishing various aspects of the disclosed system. The programming modules provided herein may exist on a single device or may span multiple devices and are provided as a non-limiting example of how processes described herein can be operated.

Processor 110 includes a print job inputs module 112 including programming configured to collect all relevant data for a print job, including input from the operator and sensor inputs from the attached printing press or presses. Processor 110 additionally includes a printing press operation module 114 including programming configured to monitor and control aspects of operation of the printing press, such as the vertical position of the printing cylinder. Processor 110 additionally includes an index factor output module 116 including programming configured to determine a recommended or ideal index factor for display to the operator according to the present disclosure.

Control module 12 further can include a touch screen device 140, speakers 150, a microphone device 160, and a printing press sensors 120. Speakers 150 and microphone device 160 are optional, and provide for optional functionality including audio output and voice commands. Control module 12 is exemplary, and the disclosure is not intended to be limited to the particular examples provided herein related to computerized devices.

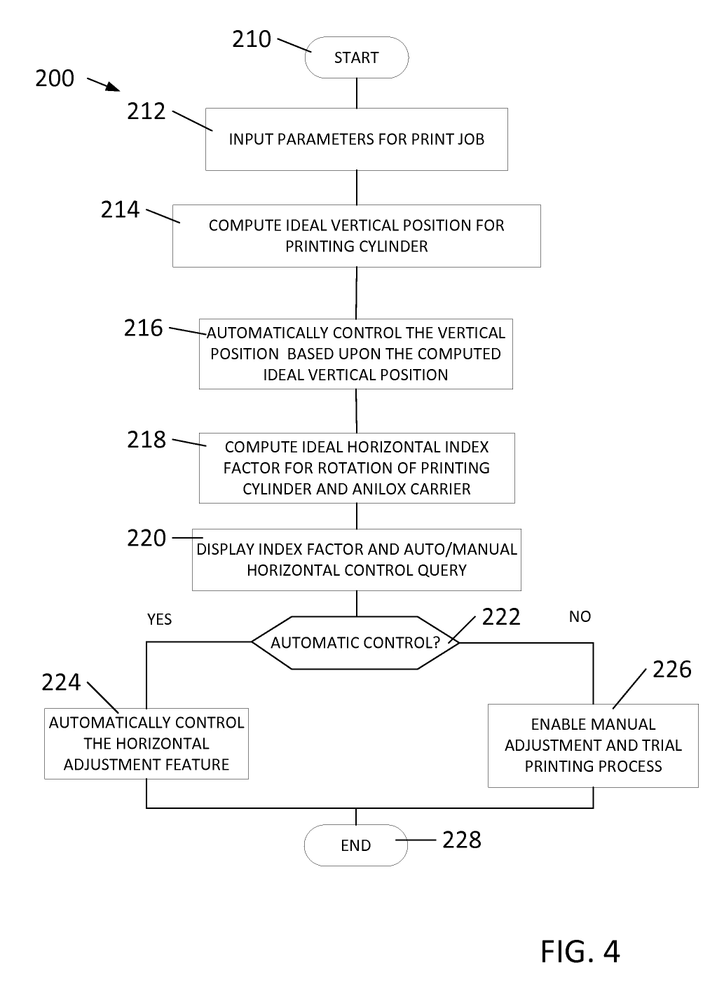

FIG. 4 is a flow chart illustrating an exemplary process for hybrid indexing adjustment of a printing press. Process 200 starts with step 210. At step 212, input parameters for a print job are collected or input. At step 214, an ideal vertical position for the printing cylinder, for example, based upon an ideal distance between centerlines of the Anilox roll and the printing cylinder, is computed or determined At step 216, the vertical position of the printing cylinder is automatically controlled based upon the determined ideal vertical position. At step 218, an ideal horizontal index factor for controlling rotation of the printing cylinder and Anilox roll is computed or determined At step 220, the ideal horizontal index factor is displayed. In one embodiment, the process can end after step 220, with the index factor displayed to the operator such that the operator can manually adjust the press based upon the index factor. In the specific embodiment of process 200, step 220 also displays a query to the operator whether the operator would like to manually or automatically adjust the press based upon the index factor. If the operator selects automatic adjustment, the process advances to step 224 where the press is automatically controlled based upon the determined index factor. If the operator selects manual control, the process advances to step 226 where the press is configured for automatic control and trial printing. At step 228, the process ends.

Process 200 is exemplary. A number of alternative embodiments of the process are envisioned, and the disclosure is not intended to be limited to the particular examples provided herein.

Control of the printing press according to the disclosed roller position control assembly is exemplary. Alternative hardware configurations, for example, enabling separate control of roller positions of the Anilox roll and the printing cylinder and the impression cylinder and the printing cylinder could similarly be controlled, with the former distance being controlled automatically and with the latter distance being controlled manually based upon a determined index factor.

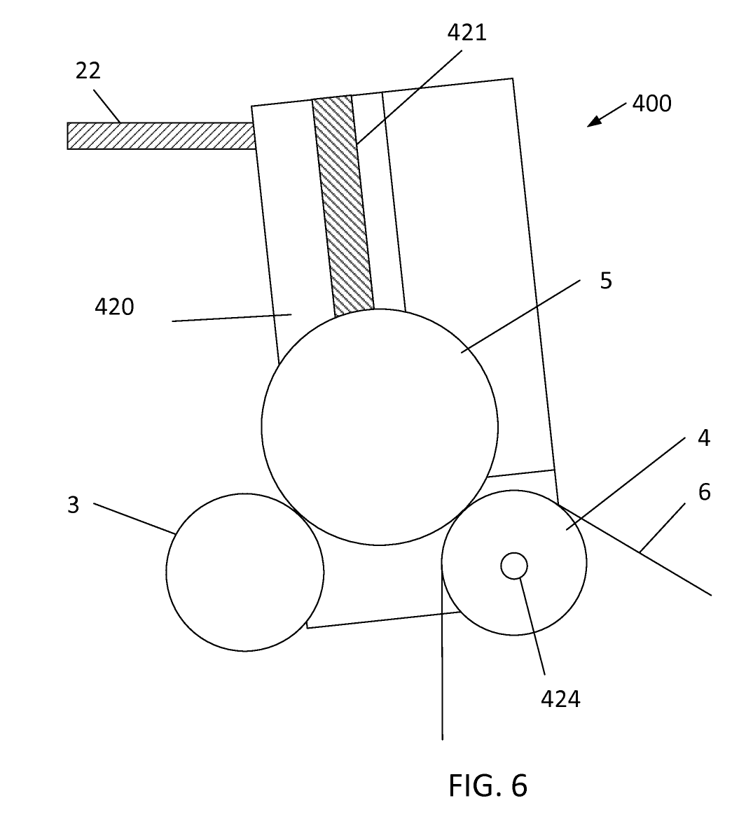

FIG. 6 illustrates an exemplary alternative hardware configuration that can be used to adjust roller positions. Roller position control assembly 400 includes printing cylinder 5, Anilox roll 3, impression cylinder 4, and printing cylinder and impression cylinder carrier 420. Carrier 420 includes pivot 424 around which carrier 420 can rotate, as controlled by horizontal control mechanism 22. Vertical position mechanism 421 is illustrated mounted to carrier 420 and controlling a vertical position of printing cylinder 5. Movement of printing cylinder 5 alters distances between printing cylinder 5 and both the Anilox roll 3 and the impression cylinder 4. Further, rotation of carrier 420 can alter distance between printing cylinder 5 and Anilox roll 3. In accordance with methods disclosed herein with the alternative hardware configuration, horizontal control mechanism 22 can be automatically controlled based upon an ideal distance between the centerline of printing cylinder 5 and Anilox roll 3. Vertical position mechanism 421 can be manually adjusted according to a provided index factor and to achieve the desired pressure upon supply paper 6. It will be appreciated that an additional step to processes disclosed herein would be required in the case of the hardware configuration of FIG. 6, including feedback adjustment of horizontal control mechanism 22 as the vertical position mechanism 421 is manually adjusted to compensate for the effect of mechanism 421 on the distance between printing cylinder 5 and Anilox 3.

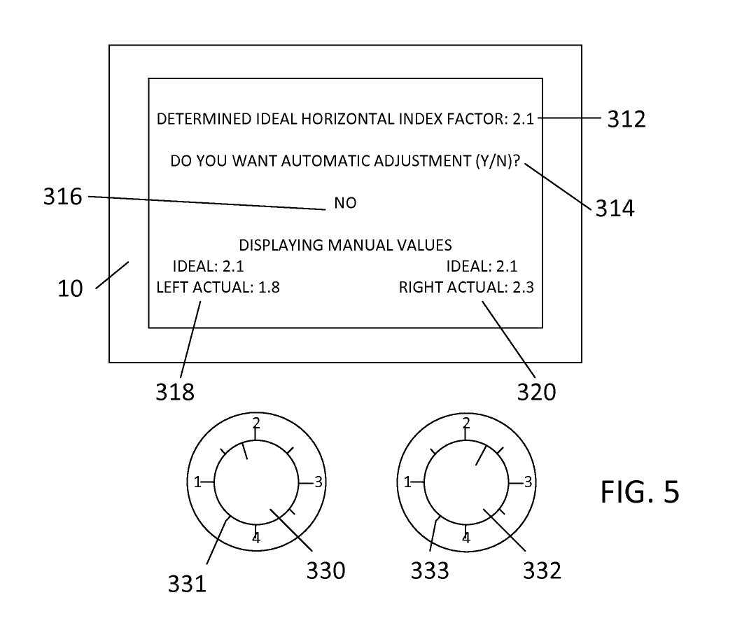

FIG. 5 illustrates a display and a pair of manual horizontal control knobs for a printing press, the display illustrating a determined index factor and aiding in manual adjustment of the knobs. It will be appreciated that roller position control for a pair of cylinders can be controlled by two control features, one controlling a left side of the rollers and another controlling a right side of the rollers. Such binary control of a the roller positions permits for greater control of the resulting print upon the paper. Touch screen device 10 is illustrated including determined index factor display 312, automatic/manual adjustment query 314, historical query response 316, optional left manual feedback control display 318, and optional right manual feedback control display 320. The feedback displays on the knobs can but do not need to include numbered indexes. Left control knob 330 is illustrated with graduated markings 331, and right control knob 332 is illustrated with graduated markings 333. In one embodiment, an operator can use displays 318 and 320 to adjust knob positions according to feedback terms provided, for example, by proximity sensors within the printing press. In another embodiment, displays 318 and 320 can be omitted, and the index value displayed can be provided in conjunction with graduation marks 331 and 333.

The index values provided herein can be unit-less. In another embodiment, the index value can be provided as a horizontal position of the horizontal control mechanism in millimeters, an angle of the carrier device in degrees, or a pressure upon the cylinders in pounds per square inch.

The disclosure has described certain preferred embodiments and modifications of those embodiments. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

1. A system for adjusting a printing press prior to operation of a print job, the system comprising:
an Anilox roll of the printing press;
a printing cylinder of the printing press;
an impression cylinder of the printing press; and
a computerized device configured to:
monitor print job parameters;
automatically control a distance between the Anilox roll and the printing cylinder;
calculate an index factor based upon the print job parameters and an ideal roller position function configured to output an ideal distance between centerlines of the printing cylinder and the impression cylinder; and
output upon a display device the index factor for manual adjustment of the printing press.

2. The system of claim 1, wherein the Anilox roll and the printing cylinder are connected to and rotate with a printing cylinder and Anilox carrier device, wherein the rotation of the carrier device controls a actual distance between centerlines of the printing cylinder and the impression cylinder.

3. The system of claim 2, wherein the carrier device comprises a vertical position mechanism controlling the distance between the Anilox roll and the printing cylinder.

4. The system of claim 2, wherein a control knob is connected to a horizontal control mechanism controlling rotation of the carrier device.

5. The system of claim 4, wherein the index factor comprises a recommended control knob setting.

6. The system of claim 1, wherein the computerized device is further configured to display an option for automatic control of the printing press based upon the index factor.

7. The system of claim 6, further comprising a manual control knob comprising a motorized input configured to move the manual control knob based upon selection of the option for automatic control.

8. The system of claim 1, wherein the computerized device is further configured to determine an ideal distance between the Anilox roll and the printing cylinder; and
wherein automatically controlling the distance between the Anilox roll and the printing cylinder
is performed prior to outputting the index factor, and
is performed based upon the determined ideal distance between the Anilox roll and the printing cylinder.

9. The system of claim 1, further comprising a manual control knob comprising an indexing feedback display.

10. A computerized process for adjusting a printing press prior to operation of a print job, the process comprising:
within a computerized device,
monitoring print job parameters;
automatically controlling a distance between centerlines of an Anilox roll of the printing press and a printing cylinder of the printing press;
calculating an index factor based upon the print job parameters and an ideal roller position function configured to output an ideal distance between centerlines of the printing cylinder and an impression cylinder of the printing press; and
displaying upon a display device the index factor for manual adjustment of the printing press.

11. The computerized process of claim 10, wherein displaying the index factor comprises displaying an index factor for adjusting a horizontal control mechanism controlling rotation of a printing cylinder and Anilox carrier to affect the desired distance between centerlines of the printing cylinder and an impression cylinder of the printing press.
